(19) United States
(12) Patent Application Publication
(10) Pub. No.: US 2010/0157265 A1
(43) Pub. Date: Jun. 24, 2010

(54) FLUID HANDLING STRUCTURE, TABLE, LITHOGRAPHIC APPARATUS, IMMERSION LITHOGRAPHIC APPARATUS, AND DEVICE MANUFACTURING METHODS

(75) Inventor: Nicolaas TEN KATE, Almkerk (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/642,669

(22) Filed: Dec. 18, 2009

Related U.S. Application Data
(60) Provisional application No. 61/193,767, filed on Dec. 22, 2008.

(51) Int. Cl. G03B 27/58; G05D 7/00

(52) U.S. Cl. 355/53; 355/72; 137/561 R

(57) ABSTRACT

A fluid handling structure comprising a conduit is described. The conduit is configured to supply fluid to (i) a space between a projection system and a substrate and/or substrate table, and/or (ii) a top surface of a substrate and/or substrate table radially outward of the space. The fluid comprises a fluid in a first phase and a fluid in a second phase. The conduit comprises at least two openings, a first phase fluid opening configured to allow passage of the first phase fluid and a second phase fluid opening configured to allow passage of the second phase fluid. There is also disclosed a table and a lithographic apparatus comprising such a conduit, as well as a method in which the conduit is used.

This application claims priority and benefit under 35 U.S.C. §119(e) to U.S. Provisional Patent Application No. 61/193,767, entitled “Fluid Handling Structure, Table, Lithographic Apparatus, Immersion Lithographic Apparatus, and Device Manufacturing Methods”, filed on Dec. 22, 2008. The content of that application is incorporated herein in its entirety by reference.

### FIELD

The invention relates to a fluid handling structure, a table, a lithographic apparatus, an immersion lithographic apparatus, and a method of manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. In an embodiment, the liquid is distilled water, although another liquid can be used. An embodiment of the invention will be described with reference to liquid. However, another fluid may be suitable, particularly a wetting fluid, an incompressible fluid and/or a fluid with higher refractive index than air, desirably a higher refractive index than water. Fluids excluding gases are particularly desirable. The point of this is to enable imaging of smaller features since the exposure radiation will have a shorter wavelength in the liquid. (The effect of the liquid may also be regarded as increasing the effective numerical aperture (NA) of the system and increasing the depth of focus.) Other immersion liquids have been proposed, including water with solid particles (e.g. quartz) suspended therein, or a liquid with a nano-particle suspension (e.g. particles with a maximum dimension of up to 10 nm). The suspended particles may or may not have a similar or the same refractive index as the liquid in which they are suspended. Other liquids which may be suitable include a hydrocarbon, such as an aromatic, a fluorohydrocarbon, and/or an aqueous solution.

Submersing the substrate or substrate and substrate table in a bath of liquid (see for example U.S. Pat. No. 4,509,852) means that there is a large body of liquid that must be accelerated during a scanning exposure. This requires additional or more powerful motors and turbulence in the liquid may lead to undesirable and unpredictable effects.

In an immersion apparatus, immersion fluid is handled by a fluid handling system, structure or apparatus. In an embodiment the fluid handling system may supply immersion fluid and therefore be a fluid supply system. In an embodiment the fluid handling system may at least partly confine immersion fluid and thereby be a fluid confinement system. In an embodiment the fluid handling system may form a barrier to immersion fluid and thereby be a barrier member, such as a fluid confinement structure. In an embodiment the fluid handling system may create or use a flow of gas, for example to help in controlling the flow and/or the position of the immersion fluid. The flow of gas may form a seal to confine the immersion fluid so the fluid handling structure may be referred to as a seal member; such a seal member may be a fluid confinement structure. In an embodiment, immersion liquid is used as the immersion fluid. In that case the fluid handling system may be a liquid handling system. In reference to the aforementioned description, reference in this paragraph to a feature defined with respect to fluid may be understood to include a feature defined with respect to liquid.

One of the arrangements proposed is for a liquid supply system to provide liquid on only a localized area of the substrate and in between the final element of the projection system and the substrate using a liquid confinement system (the substrate generally has a larger surface area than the final element of the projection system). One way which has been proposed to arrange for this is disclosed in PCT patent application publication no. WO 99/49504. As illustrated in FIGS. 2 and 3, liquid is supplied by at least one inlet onto the substrate, desirably along the direction of movement of the substrate relative to the final element, and is removed by at least one outlet after having passed under the projection system. That is, as the substrate is scanned beneath the element in a −X direction, liquid is supplied at the +X side of the element and taken up at the −X side. FIG. 2 shows the arrangement schematically in which liquid is supplied via inlet and is taken up on the other side of the element by outlet which is connected to a low pressure source. The arrows above the substrate W illustrate the direction of liquid flow, and the arrow below the substrate W illustrates the direction of movement of the substrate table. In the illustration of FIG. 2 the liquid is supplied along the direction of movement of the substrate relative to the final element, though this does not need to be the case. Various orientations and numbers of in- and out-lets positioned around the final element are possible, one example is illustrated in FIG. 3 in which four sets of an inlet with an outlet on either side are provided in a regular pattern around the final element. Arrows in liquid supply and liquid recovery devices indicate the direction of liquid flow.

A further immersion lithography solution with a localized liquid supply system is shown in FIG. 4. Liquid is supplied by two groove inlets in the direction towards the substrate as shown by the arrows present on either side of the projection system PS and is removed by a plurality of discrete outlets in the direction away from the substrate as shown by arrows, the outlets arranged radially outwardly of the inlets. The inlets and outlets can be arranged in a plate with a hole in its center and through which the projection beam is projected. Liquid is supplied by one groove inlet on one side of the projection system PS and removed by a plurality of discrete outlets on the other side of the projection system PS, causing a flow of a thin film of liquid between the projection system PS and the substrate W. The choice of which combination of inlet and outlets to use can depend on the direction of movement of the substrate W (the other combination of inlet and outlets being inactive). In the cross-sectional view of FIG. 4, arrows illustrate the direction of liquid flow in and out of the inlets/outlets.

In European patent application publication no. EP 1420300 and United States patent application publication no. US 2004-0136494, the idea of a twin or dual stage immersion lithography apparatus is disclosed. Such an apparatus has two tables for supporting a substrate. Leveling measurements are carried out with a table at a first position, without immersion liquid, and exposure is carried out with a table at a second position, where immersion liquid is present. Alternatively, the apparatus has only one table.

PCT patent application publication WO 2005/064405 discloses an all wet arrangement in which the immersion liquid is unconfined. In such a system the whole top surface of the substrate is covered in liquid. This may be advantageous because then the whole top surface of the substrate is exposed to the substantially same conditions. This has an advantage for temperature control and processing of the substrate. In WO 2005/064405, a liquid supply system provides liquid to the gap between the final element of the projection system and the substrate. That liquid is allowed to leak over the remainder of the substrate. A barrier at the edge of a substrate table prevents the liquid from escaping so that it can be removed from the top surface of the substrate table in a controlled way. Although such a system improves temperature control and processing of the substrate, evaporation of the immersion liquid may still occur. One way of helping to alleviate that problem is described in United States patent application publication no. US 2006/0119809. A member is provided which covers the substrate in all positions and which is arranged to have immersion liquid extending between it and the top surface of the substrate and/or substrate table which holds the substrate.

A bubble in an immersion system is undesirable. It is undesirable because a bubble in a space between the final element of a projection system and the substrate can lead to imaging errors, for example a defect in the pattern formed on the substrate. In an all wet system, for example, a bubble on a top surface of the substrate and/or substrate table radially outward of the immersion space may cause de-wetting of the top surface. In these and other circumstances, the bubble may be formed in situ or may be present in the liquid supplied to the immersion system. A bubble in the liquid supplied to an immersion system can find its way to the space between the final element of a projection system and the substrate, or to a top surface of the substrate and/or substrate table radially outward of the immersion space. In these or other locations, a bubble may cause an imaging and/or de-wetting problem as described above.

### SUMMARY

It is desirable, for example, to provide a fluid supply system in which the chance of bubbles finding their way (i) into a space between a projection system and a substrate and/or substrate table, and/or (ii) to a top surface of a substrate and/or substrate table radially outward of the space, is reduced, if not eliminated. The presence of the bubble in the space and/or on the top surface may then be avoided.

According to an embodiment of the invention, there is provided a fluid handling structure comprising a conduit, the conduit configured to supply fluid to (i) a space between a projection system and a substrate and/or substrate table, and/or (ii) a top surface of a substrate and/or substrate table radially outward of the space, the fluid comprising a fluid in a first phase and a fluid in a second phase, the conduit comprising at least two openings, a first phase fluid opening configured to allow passage of the first phase fluid and a second phase fluid opening configured to allow passage of the second phase fluid.

According to an embodiment, there is provided a table for an immersion lithographic apparatus, the table comprising a conduit configured to supply fluid onto a top surface of the table and/or a substrate, the fluid comprising a fluid in a first phase and a fluid in a second phase, the conduit comprising at least two openings, a first phase fluid opening configured to allow passage of the first phase fluid and a second phase fluid opening configured allow passage of the second phase fluid.

According to an embodiment, there is provided a lithographic apparatus comprising a fluid handling structure. The fluid handling structure comprises a conduit. The conduit is configured to supply fluid to (i) a space between a projection system and a substrate and/or substrate table, and/or (ii) a top surface of a substrate and/or substrate table radially outward of the space. The fluid comprises a fluid in a first phase and a fluid in a second phase. The conduit comprises at least two openings, a first phase fluid opening configured to allow passage of the first phase fluid and a second phase fluid opening configured to allow passage of the second phase fluid.

According to an embodiment, there is provided an immersion lithographic apparatus comprising a table. The table comprises a conduit. The conduit is configured to supply fluid onto a top surface of the table and/or a substrate. The fluid comprises a fluid in a first phase and a fluid in a second phase. The conduit comprises at least two openings, a first phase fluid opening configured to allow passage of the first phase fluid and a second phase fluid opening configured to allow passage of the second phase fluid.

According to an embodiment, there is provided a device manufacturing method comprising supplying fluid to (i) a space between a projection system and a substrate and/or substrate table, and/or (ii) a top surface of a substrate and/or substrate table radially outward of the space. The supplying includes supplying a fluid through a conduit of a fluid handling structure. The fluid comprises a fluid in a first phase and a fluid in a second phase. The conduit comprises at least two openings, a first phase fluid opening allowing passage of the first phase fluid and a second phase fluid opening allowing passage of the second phase fluid.

According to an embodiment, there is provided a device manufacturing method comprising supplying fluid onto a top surface of a table of an immersion lithographic apparatus and/or onto a top surface of a substrate. The supplying includes supplying a fluid through a conduit of the table. The fluid comprises a fluid in a first phase and a fluid in a second phase. The conduit comprises at least two openings, a first phase fluid opening allowing passage of the first phase fluid and a second phase fluid opening allowing passage of the second phase fluid.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict a liquid supply system for use in a lithographic projection apparatus;

FIG. 4 depicts a further liquid supply system for use in a lithographic projection apparatus;

FIG. 5 depicts a further liquid supply system for use in a lithographic projection apparatus;

FIG. 6 depicts a further liquid supply system for use in a lithographic projection apparatus;

FIG. 7 depicts a further liquid supply system for use in a lithographic projection apparatus;

FIG. 8 depicts in plan view a further liquid supply system for use in a lithographic projection apparatus;

FIG. 9 depicts in cross-sectional view a part of the liquid supply system shown in FIG. 8;

FIG. 10 depicts a schematic illustration, in cross-section, of a conduit of an embodiment of the invention;

FIG. 11 depicts a schematic illustration, in cross-section, of a variant conduit of an embodiment of the invention;

FIG. 12 depicts a schematic illustration, in cross-section, of a variant conduit of an embodiment of the invention;

FIG. 13 depicts a schematic illustration, in cross-section, of a variant conduit of an embodiment of the invention; and

FIG. 14 depicts a schematic illustration of an embodiment of the invention.

### DETAILED DESCRIPTION

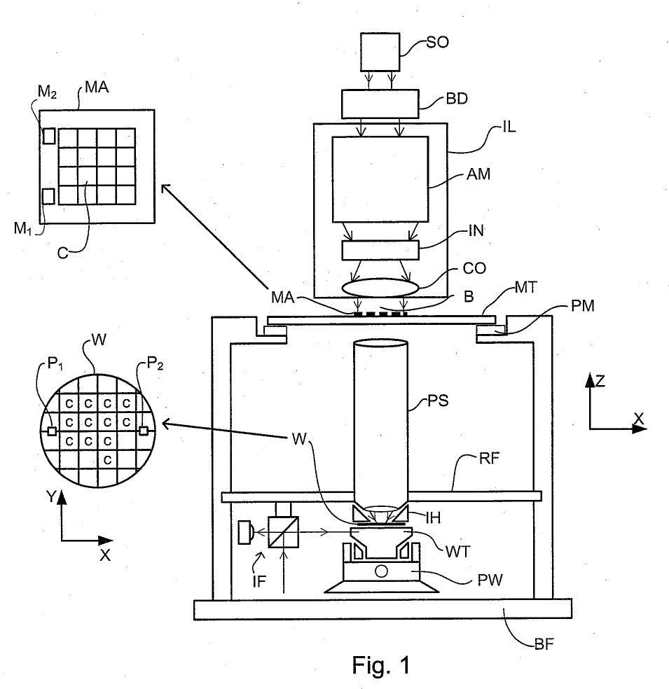

FIG. 1 schematically depicts a lithographic apparatus according to one embodiment of the invention. The apparatus comprises:

an illumination system (illuminator) IL configured to condition a radiation beam B (e.g. UV radiation or DUV radiation);

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AM for adjusting the angular intensity distribution of the radiation beam. Generally, at least the outer and/or inner radial extent (commonly referred to as a-outer and a-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

Arrangements for providing liquid between a final element of the projection system and the substrate can be classed into at least two general categories. These are the bath type (or submersed) arrangement and the localized immersion system. In the submersed arrangement, substantially the whole of the substrate and optionally part of the substrate table is submersed in a liquid, such as in a bath or under a film of liquid. The localized immersion system uses a liquid supply system to provide liquid to only a localized area of the substrate. In the latter category, the space filled by liquid is smaller in plan than the top surface of the substrate. The volume of liquid in the space that covers the substrate remains substantially stationary relative to the projection system while the substrate moves underneath that space.

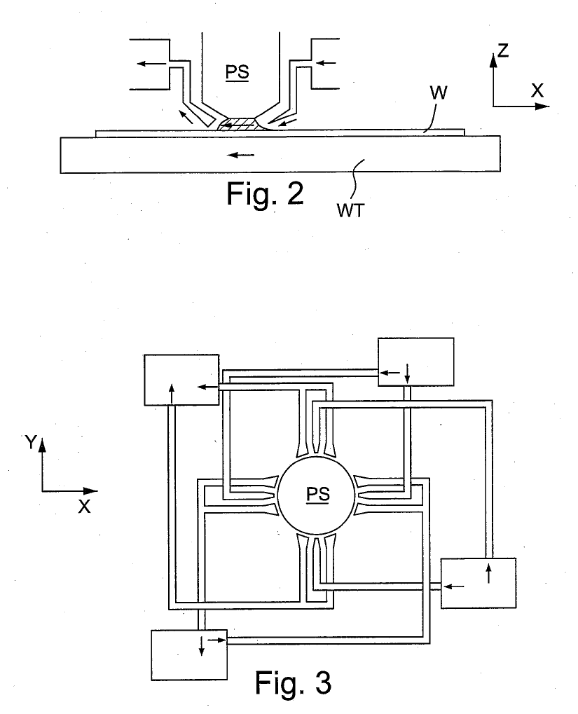

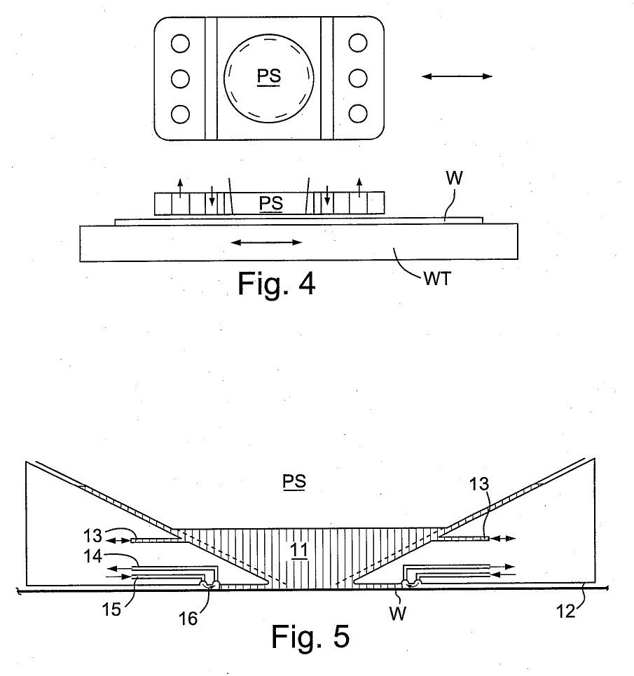

A further arrangement, to which an embodiment of the present invention may be directed, is an all wet arrangement. In an all wet arrangement the liquid is unconfined. In this arrangement, substantially the whole top surface of the substrate and all or part of the substrate table is covered in immersion liquid. The depth of the liquid covering at least the substrate is small. The liquid may be a film, such as a thin film, of liquid on the substrate. Any of the liquid supply devices of FIGS. 2-5 may be used in such a system. However, sealing features are not present in the liquid supply device, are not activated, are not as efficient as normal or are otherwise ineffective to seal liquid to only the localized area. Four different types of localized liquid supply systems are illustrated in FIGS. 2-5. The liquid supply systems disclosed in FIGS. 2-4 are described above.

FIG. 5 schematically depicts a localized liquid supply system or fluid handling structure with a barrier member or fluid confinement structure 12, which extends along at least a part of a boundary of the space between the final element of the projection system and the substrate table WT or substrate W. (Please note that reference in the following text to surface of the substrate W also refers in addition or in the alternative to a surface of the substrate table, unless expressly stated otherwise.) The fluid confinement structure 12 is substantially stationary relative to the projection system in the XY plane though there may be some relative movement in the Z direction (which is generally in the direction of the optical axis). In an embodiment, a seal is formed between the fluid confinement structure and the surface of the substrate W. The seal may be a contactless seal such as a gas seal or fluid seal.

The fluid confinement structure 12 at least partly contains liquid in the space 11 between a final element of the projection system PS and the substrate W. A contactless seal 16 to the substrate W may be formed around the image field of the projection system so that liquid is confined within the space between the substrate W surface and the final element of the projection system PS. The space is at least partly formed by the fluid confinement structure 12 positioned below and surrounding the final element of the projection system PS. Liquid is brought into the space below the projection system and within the fluid confinement structure 12 through an opening such as by liquid inlet 13. The liquid may be removed through an opening such as by liquid outlet 13. The fluid confinement structure 12 may extend a little above the final element of the projection system. The liquid level rises above the final element so that a buffer of liquid is provided. In an embodiment, the fluid confinement structure 12 has an inner periphery that at the upper end closely conforms to the shape of the projection system or the final element thereof and may, e.g., be round. At the bottom, the inner periphery closely conforms to the shape of the image field, e.g., rectangular, though this need not be the case.

The liquid is contained in the space 11 by a gas seal 16 which, during use, is formed between the bottom of the fluid confinement structure 12 and the surface of the substrate W. The gas seal is formed by gas, e.g. air or synthetic air but, in an embodiment, N₂ or another inert gas. The gas in the gas seal is provided under pressure via an opening such as inlet 15 to the gap between fluid confinement structure 12 and substrate W. The gas is extracted via an opening such as an outlet 14. The overpressure on the gas inlet 15, vacuum level on the outlet 14 and geometry of the gap are arranged so that there is a high-velocity gas flow 16 inwardly that confines the liquid. The force of the gas on the liquid between the fluid confinement structure 12 and the substrate W contains the liquid in a space 11. The inlets/outlets may be annular grooves which surround the space 11. The annular grooves may be continuous or discontinuous. The flow of gas 16 is effective to contain the liquid in the space 11. Such a system is disclosed in United States patent application publication no. US 2004-0207824.

An embodiment of the invention may be applied to any type of fluid handling system used in an immersion apparatus. The example of FIG. 5 is a localized area arrangement in which liquid is only provided to a localized area of the top surface of the substrate W at any one time.

Other arrangements and variations are possible, including fluid handling systems which make use of a single phase extractor (whether or not it works in two phase mode) as disclosed, for example, in United States patent application publication no US 2006-0038968. In this regard, it will be noted that an embodiment of a single phase extractor may work in two phase mode. In an embodiment, a single phase extractor may comprise an inlet which is covered in a porous material, e.g. a porous member which may be in the form of a plate. The porous material is used to separate liquid from gas to enable single-liquid phase liquid extraction. A chamber downstream of the porous material is maintained at a slight under pressure and is filled with liquid. The under pressure in the chamber is such that the meniscuses formed in the holes of the porous material prevent ambient gas from being drawn into the chamber. However, when the porous surface comes into contact with liquid there is no meniscus to restrict flow and the liquid can flow freely into the chamber. The porous material has a large number of small holes, e.g. of diameter in the range of 5 to 50 μm. In an embodiment, the porous material is at least slightly liquidphilic (e.g., hydrophilic in the presence of water), i.e. having a contact angle of less than 90° to the immersion liquid, e.g. water.

Another arrangement or variant is one which works on a gas drag principle. The so-called gas drag principle has been described, for example, in United States patent application publication no. US 2008-0212046 and U.S. patent application No. 61/071,621 filed on 8 May 2008. In that system the extraction openings (e.g., holes) are arranged in a shape which desirably has a corner. The corner may be aligned with the stepping and scanning directions. This reduces the force on the meniscus between two openings in the surface of the fluid handing structure for a given relative velocity between the substrate table WT (including the substrate W) and the fluid confinement structure in the step or scan direction compared to if the two outlets were aligned perpendicular to the direction of scan.

An embodiment of the invention could be applied to a fluid handling structure used in an all wet immersion apparatus. In the all wet embodiment, fluid is allowed to cover substantially the whole of the top surface of the substrate table, for example, by allowing liquid to leak out of a confinement structure which confines liquid to between the final element of projection system and the substrate. An example of a fluid handling structure for an all wet embodiment can be found in U.S. patent application No. 61/136,380 filed on 2 Sep. 2008.

Other arrangements are possible and, as will be clear from the description below, it is not important what type of liquid supply system or liquid confinement system is used or the precise construction of such a system.

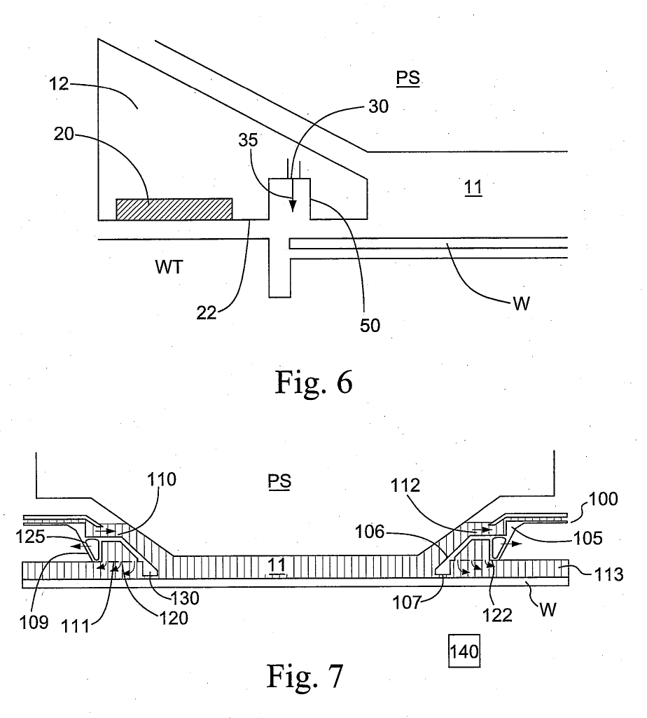

FIG. 6 illustrates schematically, in cross-section, a fluid handling system 12, which is depicted in FIG. 1 as IH. The fluid handling system 12 helps confine immersion liquid to an immersion space 11 between the projection system PS and the substrate W. The fluid handling system 12 can provide liquid to the immersion space 11. For simplicity, any openings (i.e. inlets and outlets) for liquid into and/or out of the immersion space 11 are not illustrated. The openings may be any of any suitable type and configuration such as those described with reference to the single phase extractor, the porous plate, gas-drag and all-wet arrangements. If the fluid handling system 12 is of the type used to confine immersion liquid to a localized area, one or more sealing features 20 may be present on an undersurface 22 of the fluid confinement structure 12. The undersurface 22 faces the substrate and/or substrate table WT during use. The undersurface 22 may be substantially parallel to the top surface of the substrate table WT and/or substrate W.

The sealing feature 20 may be of any type, for example any gas seal, gas knife, liquid extraction arrangement, and/or meniscus pinning feature. The meniscus pinning feature may have a point which is configured to secure a liquid meniscus. The sealing feature 20 may not be present or may be less efficient or may be deactivated, for example in an all wet embodiment.

There is an opening 30 (i.e. inlet or outlet or both) present in the fluid handling system 12. The opening 30 may be configured so that, in use, a fluid flow is directed towards the substrate table WT and/or substrate W. The opening 30 is used to provide liquid in the direction of arrow 35. The opening 30 may be configured and positioned in a surface of the fluid handling structure to direct a flow of liquid in a substantially perpendicular direction to the top surface of the substrate table WT and/or substrate W. The opening may be defined in the undersurface 22. The opening 30 may be formed in a recess 50 defined in the undersurface 22.

A fluid handling structure 100 is illustrated in cross-section in FIG. 7. The fluid handling structure 100 is designed for an unconstrained (or all wet) arrangement. In the all wet arrangement the fluid handling structure 100 provides liquid to a space 11 between the final element of a projection system PS and the substrate W and/or substrate table WT (depending on whether the substrate W, the substrate table WT, or both, are positioned under the projection system PS). The immersion liquid is supplied to the space through an inner opening 110 (e.g. inlet). The immersion liquid may be removed from the space through an inner opening 112 (e.g. outlet).

The fluid handling structure 100 supplies liquid to a top surface of the substrate W and/or substrate table WT which is not under the projection system PS. So, the fluid handling structure 100 provides liquid to a top surface of the substrate W and/or substrate table WT radially outward of the space 11. Therefore substantially the whole of the top surface of the substrate W and substrate table WT is covered in immersion liquid. e.g. a thin film of immersion liquid, during exposure.

The fluid handling structure 100 as illustrated in FIG. 7 comprises a main body 105. The main body 105 has an inner surface 106 which forms a surface which defines in part the space 11. So the space 11 is bounded at the side by the surface 106 of the main body 105 as well as at the top by the final element of the projection system PS and at the bottom by the substrate W (and/or substrate table WT or a shutter member. A shutter member is a feature which may be placed under the fluid confinement structure during, e.g., substrate swap, i.e. placement of a different substrate under the projection system for exposure. The surface of the shutter member which defines in part the space 11 during, e.g., substrate swap helps to keep immersion liquid in the space.) The main body 105 can be viewed as a liquid confinement member 12.

The main body 105 has a barrier 130 which may be part of the fluid handling structure 100. The barrier 130 may be the feature (which is associated with the fluid handling structure 100) that is closest to the substrate W. The barrier 130 could be a barrier to the flow of immersion liquid from the space (and thus the inner opening 110) radially outwardly (relative to the optical axis which passes through the liquid confinement member 12 from the projection system PS to the substrate W which would be followed by the patterned beam during exposure). The barrier 130 may function as a restriction to the flow of immersion liquid, when located above an opposing surface, e.g. substrate W and/or substrate table WT.

The main body 105 of the fluid handing structure has a radially outer surface 109 and an under surface 111 which during exposure of a substrate may face the substrate. Defined in the radially outward surface and/or the undersurface is an outer opening 120,125 (or second opening). The radially outer opening 125 is defined in the radially outer surface 109. The under outer opening 120 is defined in the under surface 111.

Immersion liquid may be supplied through the outer opening 120, 125. The immersion liquid is supplied to cover the surface of the substrate table WT and/or the substrate radially outward of the space 11. The immersion liquid radially outward of the immersion liquid in the space 11 may be referred to as bulk immersion liquid 113. The liquid flow from the outer opening, and in the bulk immersion liquid, may be referred to as the bulk flow.

Desirably, the barrier 130 is configured to substantially prevent liquid supplied from the outer opening 120, 125 from flowing into the space 11. As the barrier 130 may be configured to restrict/resist immersion fluid supplied to the space 11 from flowing radially outwardly out of the space 11 between the barrier 130 and the substrate W and/or substrate table WT as well, the barrier 130 may prevent the liquid in the immersion space 11 and liquid from the outer opening 120, 125 from significantly mixing.

A gap 107 is present between the bottom of the barrier 130 and the substrate W and/or substrate table WT. A high flow resistance is created by the barrier 130. This may be achieved by making the gap 107 height small, for example between 50-250 μm. The gap 107 is desirably 0.1-0.2 mm high. This compares with a distance of about 2-4 mm between the final element of the projection system PS and the substrate W. The gap 107 is kept small to restrict flow of liquid out of the space 11. That is, the barrier 130 of the main body 105 resists the flow of liquid out of the space 11 between the fluid handling structure 100 and the substrate W and/or substrate table WT.

As is illustrated in FIG. 7, there may be an outer extraction opening 122 (or third opening). The third opening 122 may be an outlet. The third opening 122 may be arranged to extract liquid from the top surface of the substrate W and/or substrate table WT. Such extracted immersion liquid would not have been under the projection system PS. Extracting liquid through the third opening 122 can help in controlling the velocity of the bulk flow, e.g. the velocity of the supply of the bulk flow from the fluid handling structure 100, relative to the fluid handling structure (as the bulk liquid covering the substrate may be moving relative the fluid handling structure) and/or relative to the substrate (as the supplied flow from the fluid handling structure may be moving relative to the substrate when supplied). Extraction through the third opening 122 can be controlled by controller 140.

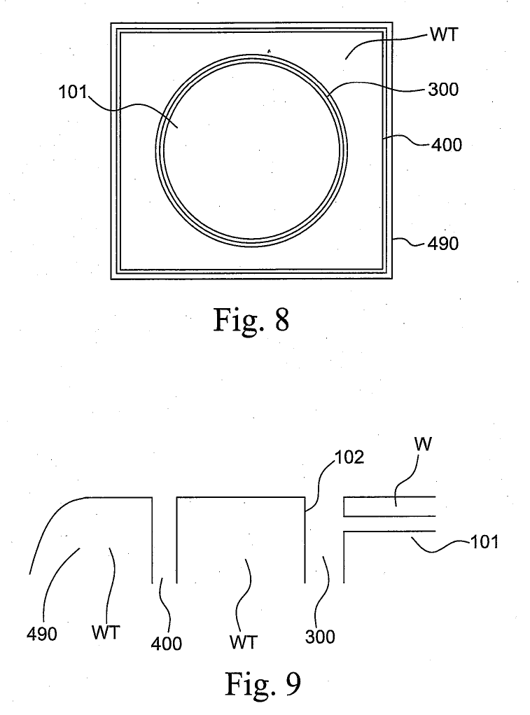

Another configuration for supplying immersion liquid is disclosed in U.S. patent application No. 61/129,061 filed on Jun. 2, 2008, which is incorporated herein by reference. As is illustrated in FIG. 8, one or more openings (e.g. outlets) defined in the substrate table WT provide immersion liquid to the top surface of the substrate table WT. An opening 300, 400 may be defined in the top surface of the substrate table WT. The immersion liquid may be supplied to the bulk flow. This is in addition to the immersion liquid supplied by the liquid handling system which provides liquid to the space 11 and may provide bulk flow. The flow from the openings may be independent of bulk immersion liquid flow supplied from an outer opening 120, 125. The opening 300, 400 may be located, in particular, adjacent (or even adjoining) a region at a high risk of de-wetting. Such a region includes: an edge of a substrate support 101 on which the substrate W will be placed, in use; and/or a region adjacent (or even adjoining) an edge 490 of the substrate table WT.

FIG. 8 is a plan view of a substrate table WT. FIG. 9 is a cross-sectional view of part of the substrate table shown in FIG. 8. A recess is defined in the top surface of the substrate table WT by a recess edge 102. The substrate support 101 is provided in the recess 102. Around the edge 102 of the recess, radially outwardly of the substrate support 101, is defined a recess opening 300 through which immersion fluid can be supplied to the top surface of the substrate table WT.

The opening 300 surrounds the substrate support 101. In an embodiment, the opening 300 is substantially annular. In an embodiment the opening 300 may be continuous (i.e. a single slit) or discontinuous (i.e. discrete openings which in an embodiments may be a series of closely spaced apart circular openings). The opening 300 has substantially the same shape as the shape of the substrate support 101 and/or substrate W.

An edge opening 400 may be provided in addition or alternatively to the recess opening 300. The opening 400 is defined in the top surface of the substrate table WT adjacent to (and even adjoining) an edge 490 of the substrate table WT. The opening 400 may have substantially the same shape as the edge of the substrate table WT, for example, in plan (e.g. in a plane parallel to the surface of the substrate table). The opening 400 may be annular. In an embodiment the opening 400 may be continuous (i.e. a single slit) or discontinuous (i.e. discrete openings which in an embodiments may be a series of closely spaced apart circular openings).

Each opening 300,400 may be present adjacent (e.g. around) a part of the substrate support 101 and substrate edge 490, respectively. For example, in an embodiment, liquid may be allowed to flow over a restricted number of edges 490, for example, two (desirably opposing) edges of the substrate table WT. In that instance the opening 400 may be restricted to particular edges, for example adjacent only to the two edges over which liquid is allowed to flow.

A bubble, e.g. gas, in the liquid supplied to an immersion system can find its way to the space 11 during exposure, or to a top surface of the substrate and/or substrate table radially outward of the space 11. In either or both of these locations the bubble may cause a problem as previously described. The supply of liquid to each of these locations is through an opening e.g. 30, 110, 120, 125, 300, 400 and through a conduit connected to the opening.

Providing the conduit at least two openings, each opening configured for the passage of a different phase of fluid, is desirable so as to help prevent the supply of a bubble in the immersion liquid to the immersion system. The conduit may have a first phase fluid opening and a second phase fluid opening. The first phase fluid opening may be configured for the passage of a first phase fluid, such as gas. The second phase fluid opening may be configured for the passage of a second phase fluid, such as liquid.

The liquid supplied to the immersion system as immersion liquid may comprise gas either as a bubble in the immersion liquid or dissolved in the immersion liquid. The aforementioned arrangement is desirable as it enables the removal of gas from the liquid before the liquid is provided to the immersion system. Thus, in helping to prevent the presence of a bubble in the space between the final element of a projection system and the substrate, and/or on a top surface of the substrate and/or substrate table radially outward of the immersion space, one or more of the aforementioned, or other, problems are alleviated.

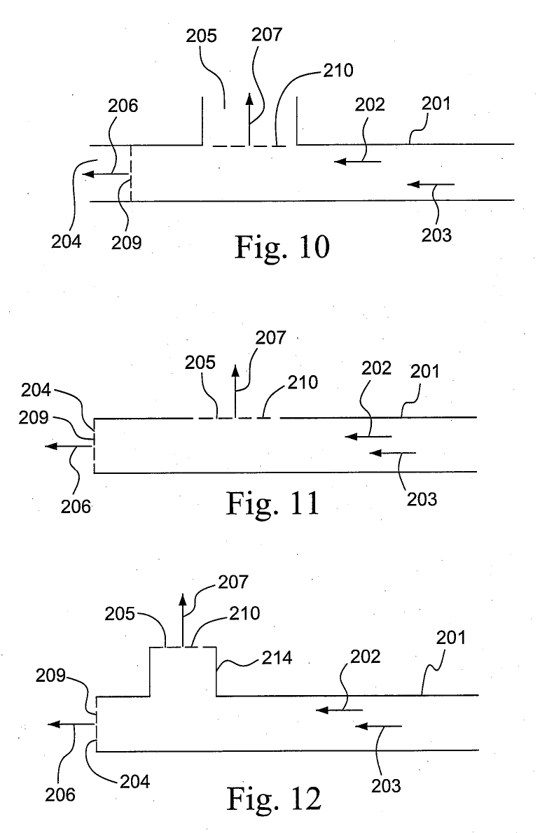

A conduit according to an embodiment of the invention is illustrated in FIG. 10. The conduit 201 is configured to supply fluid to (i) a space between a projection system and a substrate and/or substrate table, and/or (ii) a top surface of a substrate and/or substrate table radially outward of the space 11. The fluid comprises a fluid in a first phase 202 and a fluid in a second phase 203. The conduit comprises at least two openings: a first phase fluid opening 204 configured to allow passage of the first phase fluid 202; and a second phase fluid opening 205 configured to allow passage of the second phase fluid 203. Both openings 204, 205 are outlets with respect to the conduit.

The fluid 206 which passes through the first phase fluid opening 204 is supplied to (i) a space between a projection system and a substrate and/or substrate table, and/or (ii) a top surface of a substrate and/or substrate table radially outward of the space. (Note that liquid may be supplied to the space 11 and radially outward of the space because the first fluid opening 204 may comprise two different openings, one to supply the first phase fluid to the space and the other to supply the first phase fluid radially outward of the space 11). The first phase fluid opening 204 may supply immersion liquid and so with respect to the immersion system, such as the immersion space 11, is an inlet. The fluid 207 (e.g. gas) which passes through the second phase fluid opening 205 is not supplied to the aforementioned space and/or top surface. The fluid 207 is e.g. supplied to a gas extraction device, or vented e.g. to a stage environment.

The fluid in the first phase 202 may be a liquid, e.g. immersion liquid. As described earlier, the immersion liquid may be water, a high numerical aperture liquid, or any other kind of liquid or liquid mixture. The fluid in the second phase 203 may be a gas, e.g. air. The fluid in the second phase 203 and the fluid in the first phase 202 may be present in the conduit 101 as gas bubbles in immersion liquid, respectively. The fluid in the second phase 203 may be present as dissolved gas in the liquid. The dissolved gas may be released as gas bubbles, for example, when the liquid pressure decreases. By the time the immersion liquid is supplied to the immersion system the dissolved gas may be released, for example, because of a change in pressure. The pressure difference might be between the remote system from which the liquid is supplied and the opening through which the liquid is supplied due to a fluctuation, such as a decrease or increase, in velocity of this liquid. Hereafter the first phase fluid opening 204 and the second phase fluid opening 205 may be referred to as the liquid opening 204 and the gas opening 205. An embodiment of the invention may be applied to a situation where phases are different from the liquid phase and/or gas phase as described.

With each of the liquid opening 204 and gas opening 205 may be associated a selectively permeable member. The first phase fluid permeable member 209 is hereafter referred to, as a liquid permeable member or porous member. The second phase fluid permeable member 210 is hereafter referred to as a gas permeable member, such as a membrane and/or a sieve, which allows the passage of one of the fluid phases but not the other. In an alternative or in addition, the porous member 209 may be liquidphilic, e.g. made of glass or quartz. Liquid may have a contact angle of less than 90 degrees with the surface of the porous member 209, such that, e.g., the liquid capillary underpressure in the pores is higher than the pressure drop across the porous member 209. The gas permeable member 210 may be liquidphobic, e.g. made of a poly(tetrafluoroethylene) (PFTE), e.g., Teflon, like Gore-Tex. Liquid may have a contact angle of greater than 90 degrees with the gas permeable member 210, such that e.g. the liquid capillary overpressure in the pores is higher than the pressure drop across the gas permeable member 210. The liquidphilicity, liquidphobicity, and/or desired contact angle of a porous member or a gas permeable member may be a result of the material from which the member is made, or achieved by a coating present on the member.

As illustrated in FIG. 10 the porous member 209 may be located upstream of the liquid opening 204 in the liquid flow through the liquid opening 204. The gas permeable member 210 may be located upstream of the gas opening 205 in the fluid flow through the gas opening 205.

As illustrated in FIG. 11 the porous member 209 may be located in the liquid opening 204. The gas permeable member 210 may be located in the gas opening 205. In an embodiment, the porous member 209 may cover the liquid opening 204; the gas permeable member 210 may cover the gas opening 205.

In FIG. 12 is shown an embodiment in which the gas permeable member 210 is located in the gas opening 205 and the gas opening 205 is positioned in a branch 214 of the conduit 201. The porous member 209 may be located in the liquid opening 204. The liquid opening 204 may be positioned in a branch (not shown in FIG. 11) of the conduit 201.

Other relative positions between a porous member and liquid opening, and between a gas permeable and gas opening are possible, including combinations of the above mentioned configurations.

One or more of the parts of the conduit downstream (in the direction of fluid flow) of each fluid permeable member may each be liquidphilic or liquidphobic, and may have a certain (e.g. predetermined) contact angle. For example, the part of the conduit downstream of the porous member 209 may be liquidphilic, which may be achieved by having an appropriate coating applied to the surface of the conduit and/or by the use of an appropriate material for this part of the conduit. In an alternative or in addition the part of the conduit downstream of the porous member 209 may have a contact angle of less than 70°, more specifically less than 30°.

The whole, substantially the whole, or specific parts of the conduit 201 may be liquidphilic or liquidphobic, and have a desired contact angle.

In an alternative, or in addition to the aforementioned, one or more of the surfaces of the conduit surrounding the openings, e.g. the surface of the conduit surrounding the liquid opening 204 and/or the surface of the conduit surrounding the gas opening 205, may each be liquidphilic or liquidphobic, and have a desired (e.g. certain) contact angle. For example, the surface of the conduit surrounding the liquid opening 204 may be liquidphilic and may have a contact angle of less than 70°, desirably less than 30°. In an alternative or in addition, the surface of the conduit surrounding the gas opening may be liquidphobic and may have a contact angle of more than 90°, desirably more than 100°.

It may be desirable for the pressure difference over the porous member 209 to be relatively high. This arrangement may help to obtain a certain pressure buildup (i.e. pressure differential to exceed a pressure threshold) upstream of the porous member 209 to help ensure that gas present in the fluid flow as the second phase fluid 203 is vented through the gas opening 205. A certain pressure difference over the porous member 209 (i.e. pressure differential exceeding a pressure threshold) may help the functioning of the porous member 209. For example, in case the porous member 209 has a liquidphilic surface, the porous member may need a certain pressure difference applied over it for it to function properly. A certain pressure difference may be necessary to help ensure that gas present in the fluid flow as the second phase fluid 203 does not pass the liquidphilic porous member. A way to increase the pressure difference over the porous member 209 may be to limit the number of holes and/or to limit the area of each of the holes and/or to limit the total area of the holes present in the porous member.

The conduit 201 as illustrated in FIGS. 10-12 is desirable to help prevent the presence of bubbles in the space, and/or on a top surface of the substrate and/or substrate table radially outward of the space. It is desirable because the conduit separates the fluid in the first phase 202 from the fluid in the second phase 203 such that mainly only the fluid in the first phase 202, e g immersion liquid, is supplied to the aforementioned space and/or top surface, and not fluid in the second phase 203, e.g. gas.

Variants of the configurations of the conduit 201 illustrated in FIGS. 10-12 are within the scope of the invention. As illustrated in, for example, FIG. 10 the liquid opening 204 is positioned downstream of the gas opening 205. In a variant a liquid opening 204 is positioned upstream (in the fluid flow) of the gas opening 205. In an embodiment the gas and liquid openings are at substantially the same point in the conduit (in the flow of fluid); that is they are not positioned downstream or upstream of each other.

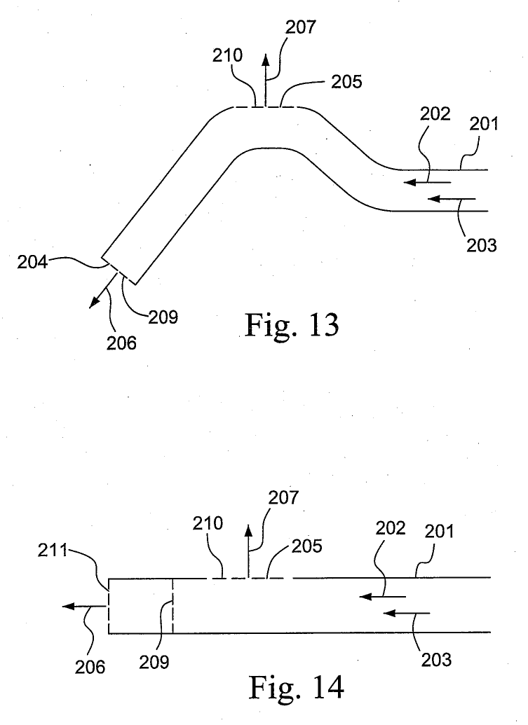

In an embodiment it may be desirable to position the gas opening, which may be regarded as a gas bleed, at a location in the conduit where the gas naturally tends to gather. In view of the overpressure applied by the surrounding liquid and the positioning of the liquid opening along the conduit, such a position may be in an upwardly facing side of the conduit (see, e.g., FIG. 13). Positioning the gas opening at a location where the gas tends to accumulate may help to reduce the amount of gas present in the fluid flow between the gas and liquid openings, for example immediately or directly upstream of the liquid outlet. This arrangement may help to reduce the amount of undesired gas present in the fluid flow directly downstream of the fluid opening.

FIG. 13 illustrates a conduit 201 from a side view. As illustrated in FIG. 13, the gas permeable member 210 may be located at a higher position than the porous member 209. This may be desirable where the fluid in the second phase 203, e.g. gas, has a lower density than the fluid in the first phase 202, e.g. immersion liquid. It is desirable because the fluid with the lower density, e.g. the gas, will have a natural tendency to rise above the fluid with the higher density, e.g. the immersion liquid. By positioning the gas permeable member 210 above the porous member 209, less immersion liquid may accumulate near the gas permeable member 210 so fluid that passes through the gas permeable member is less likely to contain liquid. Additionally or alternatively, as a consequence of the arrangement of the gas and liquid openings 204, 205, less gas may accumulate near the porous member 209, so that the fluid that passes through the porous member is less likely to include gas. Having the gas opening 205 above and preceding the liquid opening 204 in the direction of fluid flow through the conduit 201 may increase the efficiency of the system. In an alternative or in addition, the gas permeable member 210 may be located at the substantially highest position of the conduit 201, and/or the porous member 209 may be located at the substantially lowest position of the conduit 201, or at least the part of the conduit present in the immersion system.

In an embodiment, the conduit may extend downstream beyond one or more of the openings. So the conduit might not abruptly end downstream of the gas and/or liquid opening. The conduit may extend beyond the gas and/or liquid opening to a further opening. The further opening may supply liquid 206 directly to a part of the immersion system other than that supplied by the liquid opening 204. For example the liquid opening may supply the space 11 and the further opening may supply liquid to a top surface of a substrate and/or substrate table radially outward of the space. One or more of the openings may each comprise a plurality of openings. If an opening has a plurality of openings, each opening of these plurality of openings may supply a different part of the immersion system and e.g. one of the plurality of openings may be located downstream in the fluid flow of another of the plurality of openings.

A variation of the conduit is in the arrangement of a plurality of openings. Discrete gas openings may be positioned around the periphery (e.g. circumference) of a feature of the immersion system, for example the fluid handling structure with adjacent openings being spaced apart. The opening may be spaced apart equidistantly or unequally apart. Two adjoining openings may be spaced apart by an angular displacement with respect to the axis of the feature, such as the optical axis. The angular displacement may 5, 10, 20, 45, 90, or 180 degrees. A conduit may comprise multiple, e.g. 2, 4, 8, 16, 32, liquid openings around the periphery of the fluid handling structure.

If the porous member 209 comprises only a limited number of holes through which the fluid 206 can pass this may cause jets to form directly downstream of the porous member 209. This could occur especially when the mass flow through the porous member 209 is high. As mentioned, a limited number of holes would be desirable to help ensure a relatively high pressure difference over the porous member. However, as the supply of e.g. immersion liquid to the immersion space is desirably gradual with a smooth flow, having jets in the fluid flow is undesirable. Having a further porous member 211 downstream in the fluid flow of the porous member 209, as illustrated in FIG. 14, may help remove the jets from the liquid flow. The downstream porous member 211 may have a larger number of holes and/or larger hole sizes compared to the porous member 209, to smoothen the supply flow.

The holes in the porous member 209 may direct fluid in a direction towards areas of the downstream porous member 211 between a plurality of holes in this downstream porous member 211. The holes of the downstream porous member 211 are, e.g., not aligned with the holes of the porous member 209. The plurality of holes in the porous member 209 may be defined so that they do not overlap with the holes of the downstream porous member 211. This arrangement may be effective to disrupt the flow of liquid through the holes of the porous member 209 and means that the resulting flow through the holes of the downstream porous member 211 may be higher than previously achieved. The resulting flow, e.g. the flow of immersion liquid to the immersion space, is gradual and smooth. Desirably the flow is laminar. Additional information is disclosed in U.S. patent application No. 61/071,621 filed on 8 May 2008, which is incorporated herein by reference.

The described conduit and its many possible variations may be used in a device manufacturing method. A device manufacturing method may comprise supplying fluid to (i) a space between a projection system and a substrate and/or substrate table, and/or (ii) a top surface of a substrate and/or substrate table radially outward of the space. The aforementioned supplying includes supplying a fluid through a conduit. The fluid comprises a fluid in a first phase, e.g. immersion liquid, and a fluid in a second phase, e.g. gas. The conduit comprises at least two openings, a liquid opening configured to allow passage of the e.g. immersion liquid, and a gas opening configured to allow passage of the gas. This method may be applied in one or more of embodiments of the invention. The openings may be configured for exclusive passage of a fluid phase, for example, the liquid opening may be configured for exclusive passage of immersion liquid and the gas opening may be configured for exclusive passage of gas.

The described conduit and its many possible variations can be used in various embodiments.

In an embodiment the conduit may be comprised in a fluid handling structure. This fluid handling structure may specifically be arranged to accommodate the bath type arrangement, the localized immersion arrangement, or the all wet arrangement. In all these arrangements one or more of the liquid openings of the conduit may be configured to supply liquid to a space between a projection system and a substrate and/or substrate table. Regarding the all wet arrangement and the bath type arrangement, the conduit may alternatively or in addition be configured to supply liquid to a top surface of a substrate and/or substrate table radially outward of the space.

In an additional and/or alternative embodiment, the conduit may be comprised in the configuration for supplying immersion liquid as explained with reference to FIG. 8 (e.g. concerning an all wet arrangement). At least one opening 300, 400 in the substrate table WT provides immersion liquid to the top surface of the substrate table WT. The openings 300, 400 may be in the top surface of the substrate table WT. If the openings 300, 400 are defined in the top surface of the substrate table WT, the conduit may be upstream in the flow of fluid supplied from the openings. The conduit may be within the substrate table WT. Each conduit and associated opening 300, 400 may be used to supply immersion liquid to the top surface of the substrate table WT.

By application of an embodiment of the invention, a fluid supply system may be operated to reduce the risk, or even eliminate the risk, of a bubble finding its way to a top surface of a substrate and/or substrate table radially outward of the space between a projection system and a substrate and/or substrate table.

In an embodiment, there is a lithography apparatus comprising the conduit in, for example, the above mentioned fluid handling structure and/or in a substrate stable WT as described previously. Further embodiments may be the conduit to supply fluid, and a lithographic apparatus comprising the conduit to supply fluid. It will be appreciated that most, if not all, of the aforementioned embodiments may be applied in a device manufacturing method.

It will be appreciated that the above description in certain cases makes reference to materials or coatings being hydrophobic or hydrophilic. This is relevant to the case where the immersion liquid used is water. However, other liquids or fluids may be used as the immersion liquid. In this case the terms hydrophobic and hydrophilic should be read as being liquidphobic or liquidphilic or lipophobic or lipophilic. Hydrophobic means a receding contact angle of greater than 90°, desirably greater than 100, 120, 130 or 140°. The contact angle in one embodiment is less than 180°. Hydrophilic means a receding contact angle of less than 90°, desirably less than 80°, less than 70°, less than 60° or less than 50°. In one embodiment the contact angle is more than 0°, desirably more than 10°. These angles may be measured at room temperature (20° C.) and atmospheric pressure.

As will be appreciated, any of the above described features can be used with any other feature and it is not only those combinations explicitly described which are covered in this application.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm). The term “lens”, where the context allows, may refer to any one or combination of various types of optical components, including refractive and reflective optical components.

While specific embodiments of the invention have been described above, it will be appreciated that the invention may be practiced otherwise than as described. For example, the embodiments of the invention may take the form of a computer program containing one or more sequences of machine-readable instructions describing a method as disclosed above, or a data storage medium (e.g. semiconductor memory, magnetic or optical disk) having such a computer program stored therein. Further, the machine readable instruction may be embodied in two or more computer programs. The two or more computer programs may be stored on one or more different memories and/or data storage media.

The controllers described herein may each or in combination be operable when the one or more computer programs are read by one or more computer processors located within at least one component of the lithographic apparatus. The controllers may each or in combination have any suitable configuration for receiving, processing, and sending signals. One or more processors are configured to communicate with the at least one of the controllers. For example, each controller may include one or more processors for executing the computer programs that include machine-readable instructions for the methods described above. The controllers may include data storage medium for storing such computer programs, and/or hardware to receive such medium. So the controller(s) may operate according the machine readable instructions of one or more computer programs.

One or more embodiments of the invention may be applied to any immersion lithography apparatus, in particular, but not exclusively, those types mentioned above and whether the immersion liquid is provided in the form of a bath, only on a localized surface area of the substrate, or is unconfined. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion fluid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more fluid openings including one or more liquid openings, one or more gas openings or one or more openings for two phase flow. The openings may each be an inlet into the immersion space (or an outlet from a fluid handling structure) or an outlet out of the immersion space (or an inlet into the fluid handling structure). In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

In an embodiment, there is provided a fluid handling structure comprising a conduit. The conduit is configured to supply fluid to (i) a space between a projection system and a substrate and/or substrate table, and/or (ii) a top surface of a substrate and/or substrate table radially outward of the space. The fluid comprises a fluid in a first phase and a fluid in a second phase. The conduit comprises at least two openings, a first phase fluid opening configured to allow passage of the first phase fluid and a second phase fluid opening configured to allow passage of the second phase fluid.

The first phase fluid opening may be associated with a first phase fluid permeable member, and the second phase fluid opening may be associated with a second phase fluid permeable member. The first phase fluid permeable member and/or the second phase fluid permeable member may comprise a membrane and/or sieve.

The first phase fluid opening may be configured to allow substantially exclusively passage of the first phase fluid, and the second phase fluid opening may be configured to allow substantially exclusively passage of the second phase fluid.

The conduit may comprise a further permeable member downstream of the first phase fluid permeable member, which may be configured to smoothen the fluid flow therethrough.

The second phase fluid permeable member may be positioned higher than the first phase fluid permeable member. The second phase fluid permeable member may be located at the substantially highest point of the conduit, at least in the part of the conduit in the immersion system.

The conduit may be configured to supply immersion liquid. The first phase fluid may be liquid and the second phase fluid may be gas. The openings may be outlets with respect to the conduit.

In an embodiment, there is provided a table for an immersion lithographic apparatus. The table comprises a conduit configured to supply fluid onto a top surface of the table and/or a substrate. The fluid comprises a fluid in a first phase and a fluid in a second phase. The conduit comprises at least two openings, a first phase fluid opening configured to allow passage of the first phase fluid and a second phase fluid opening configured to allow passage of the second phase fluid.

The first phase fluid opening may be associated with a first phase fluid permeable member, and the second phase fluid opening is associated with a second phase fluid permeable member. The first phase fluid opening may be configured to allow substantially exclusively passage of the first phase fluid, and the second phase fluid opening may be configured to allow substantially exclusively passage of the second phase fluid. The second phase fluid permeable member may be positioned higher than the first phase fluid permeable member.

The conduit may be configured to supply immersion liquid. The first phase fluid may be liquid and the second phase fluid may be gas.

In an embodiment, there is provided a lithographic apparatus comprising a fluid handling structure comprising a conduit. The conduit is configured to supply fluid to (i) a space between a projection system and a substrate and/or substrate table, and/or (ii) a top surface of a substrate and/or substrate table radially outward of the space. The fluid comprises a fluid in a first phase and a fluid in a second phase. The conduit comprises at least two openings, a first phase fluid opening configured to allow passage of the first phase fluid and a second phase fluid opening configured to allow passage of the second phase fluid.

In an embodiment, there is provided an immersion lithographic apparatus comprising a table comprising a conduit. The conduit is configured to supply fluid onto a top surface of the table and/or a substrate. The fluid comprises a fluid in a first phase and a fluid in a second phase. The conduit comprises at least two openings, a first phase fluid opening configured to allow passage of the first phase fluid and a second phase fluid opening configured to allow passage of the second phase fluid.

In an embodiment, there is provided a device manufacturing method comprising supplying fluid to (i) a space between a projection system and a substrate and/or substrate table, and/or (ii) a top surface of a substrate and/or substrate table radially outward of the space. The supplying includes supplying a fluid through a conduit of a fluid handling structure. The fluid comprises a fluid in a first phase and a fluid in a second phase. The conduit comprises at least two openings, a first phase fluid opening configured to allow passage of the first phase fluid, and a second phase fluid opening configured to allow passage of the second phase fluid.

In an embodiment, there is provided a device manufacturing method comprising supplying fluid onto a top surface of a table of an immersion lithographic apparatus and/or onto a top surface of a substrate. The supplying includes supplying a fluid through a conduit of the table. The fluid comprises a fluid in a first phase and a fluid in a second phase. The conduit comprises at least two openings, a first phase fluid opening configured to allow passage of the first phase fluid and a second phase fluid opening configured to allow passage of the second phase fluid.

The descriptions above are intended to be illustrative, not limiting. Thus, it will be apparent to one skilled in the art that modifications may be made to the invention as described without departing from the scope of the claims set out below.

1. A fluid handling structure comprising a conduit, the conduit configured to supply fluid to (i) a space between a projection system and a substrate and/or substrate table, and/or (ii) a top surface of a substrate and/or substrate table radially outward of the space, the fluid comprising a fluid in a first phase and a fluid in a second phase, the conduit comprising at least two openings, a first phase fluid opening configured to allow passage of the first phase fluid and a second phase fluid opening configured to allow passage of the second phase fluid.

2. The fluid handling structure of claim 1, wherein the first phase fluid opening is associated with a first phase fluid permeable member, and the second phase fluid opening is associated with a second phase fluid permeable member.

3. The fluid handling structure of claim 2, wherein the first phase fluid permeable member and/or the second phase fluid permeable member comprise a membrane and/or sieve.

4. The fluid handling structure of claim 1, wherein the first phase fluid opening is configured to allow passage substantially exclusively of the first phase fluid, and the second phase fluid opening is configured to allow passage substantially exclusively passage of the second phase fluid.

5. The fluid handling structure of claim 2, wherein the conduit comprises a further permeable member downstream of the first phase fluid permeable member, the further permeable member configured to smoothen the fluid flow therethrough.

6. The fluid handling structure of claim 2, wherein the second phase fluid permeable member is positioned higher than the first phase fluid permeable member.

7. The fluid handling structure of claim 6, wherein the second phase fluid permeable member is located at the substantially highest point of the conduit, at least in the part of the conduit in the immersion system.

8. The fluid handling structure of claim 1, wherein the conduit is configured to supply immersion liquid.

9. The fluid handling structure of claim 1, wherein the first phase fluid is liquid and the second phase fluid is gas.

10. The fluid handling structure of claim 1, wherein the openings are outlets with respect to the conduit.

11. A table for an immersion lithographic apparatus, the table comprising a conduit configured to supply fluid onto a top surface of the table and/or a substrate, the fluid comprising a fluid in a first phase and a fluid in a second phase, the conduit comprising at least two openings, a first phase fluid opening configured to allow passage of the first phase fluid and a second phase fluid opening configured allow passage of the second phase fluid.

12. The table of claim 11, wherein the first phase fluid opening is associated with a first phase fluid permeable member, and the second phase fluid opening is associated with a second phase fluid permeable member.

13. The table of claim 12, wherein the second phase fluid permeable member is positioned higher than the first phase fluid permeable member.

14. The table of claim 11, wherein the first phase fluid opening is configured to allow substantially exclusively passage of the first phase fluid, and the second phase fluid opening is configured to allow substantially exclusively passage of the second phase fluid.

15. The table of claim 11, wherein the conduit is configured to supply immersion liquid.

16. The table of claim 11, wherein the first phase fluid is liquid and the second phase fluid is gas.

17. A lithographic apparatus comprising a fluid handling structure, the fluid handling structure comprising a conduit, the conduit configured to supply fluid to (i) a space between a projection system and a substrate and/or substrate table, and/or (ii) a top surface of a substrate and/or substrate table radially outward of the space, the fluid comprising a fluid in a first phase and a fluid in a second phase, the conduit comprising at least two openings, a first phase fluid opening configured to allow passage of the first phase fluid and a second phase fluid opening configured to allow passage of the second phase fluid.

18. An immersion lithographic apparatus comprising a table, the table comprising a conduit, the conduit configured to supply fluid onto a top surface of the table and/or a substrate, the fluid comprising a fluid in a first phase and a fluid in a second phase, the conduit comprising at least two openings, a first phase fluid opening configured to allow passage of the first phase fluid and a second phase fluid opening configured to allow passage of the second phase fluid.

19. A device manufacturing method comprising supplying fluid to (i) a space between a projection system and a substrate and/or substrate table, and/or (ii) a top surface of a substrate and/or substrate table radially outward of the space, the supplying including supplying a fluid through a conduit of a fluid handling structure, the fluid comprising a fluid in a first phase and a fluid in a second phase, the conduit comprising at least two openings, a first phase fluid opening allowing passage of the first phase fluid and a second phase fluid opening allowing passage of the second phase fluid.

20. A device manufacturing method comprising supplying fluid onto a top surface of a table of an immersion lithographic apparatus and/or onto a top surface of a substrate, the supplying including supplying a fluid through a conduit of the table, the fluid comprising a fluid in a first phase and a fluid in a second phase, the conduit comprising at least two openings, a first phase fluid opening allowing passage of the first phase fluid and a second phase fluid opening allowing passage of the second phase fluid.
